(19) United States
(12) Patent Application Publication
(10) Pub. No.: US 2007/0237575 A1
(43) Pub. Date: Oct. 11, 2007

(54) Flexible shaft inline coupler

(75) Inventors: Guy L. Dilno, Chandler, AZ (US); David M. Eschborn, Gilbert, AZ (US); Clayton G. Saffell, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/402,688

(22) Filed: Apr. 11, 2006

(51) Int. Cl. B25G 3/00

(52) U.S. Cl. 403/410

(57) ABSTRACT

A coupler is provided for coupling a first cable to a second cable, where the first cable includes a male adapter having a male drive feature extending therefrom, and the second cable includes a female adapter having a female drive feature extending therefrom, each adapter including a radial flange. In one embodiment, and by way of example only, the coupler includes a cylinder, a female drive receiving end, and a male drive receiving. The male drive receiving end is spaced a predetermined distance apart from the female drive receiving end such that when the female and male drive features are disposed in the cylinder channel, a portion of the male drive feature is disposed in the female drive feature and is capable of moving axially therethrough in response to a predetermined torque applied to the first cable.

### STATEMENT REGARDING FEDERALLY SPONSORED RESEARCH OR DEVELOPMENT

This invention was made with Government support under F33657-02-C2000 awarded by the U.S. Air Force to Middle River Aircraft Systems. The Government has certain rights in this invention.

### TECHNICAL FIELD

The present invention relates to aircraft engine thrust reverser actuation systems and, more particularly, to a system for coupling shafts of the aircraft engine thrust reverser actuation system.

### BACKGROUND

When a jet-powered aircraft lands, the landing gear brakes and aerodynamic drag (e.g., flaps, spoilers, etc.) of the aircraft may not, in certain situations, be sufficient to slow the aircraft down in the required amount of runway distance. Thus, jet engines on most aircraft include thrust reversers to enhance the braking of the aircraft. When deployed, a thrust reverser redirects the rearward thrust of the jet engine to a generally or partially forward direction to decelerate the aircraft. Because at least some of the jet thrust is directed forward, the jet thrust also slows down the aircraft upon landing. When the thrust reversers are no longer needed, they are returned to their original, or stowed, position. In the stowed position, the thrust reversers do not redirect the jet engine's thrust. In some cases, thrust reversers are used during flight. For example, the thrust reversers may be used to decelerate the aircraft.

The thrust reversers typically include independent transcowls that are moved into and out of a housing between stowed and deployed positions by actuators. Power to drive the actuators may come from dual power drive units (PDUs), which may be electrically, hydraulically, or pneumatically operated, depending on the system design. A drive train that includes one or more drive mechanisms, such as flexible rotating drive shafts, may interconnect the actuators and the PDUs to transmit the PDUs' drive force to the moveable thrust reverser components and to synchronize the transcowls.

Recently, some systems have included a flexible shaft that couples a drive unit of one transcowl to a drive unit of another transcowl to provide synchronized deployment thereof. However, it has been found that the flexible shafts may experience relatively high torsional loads that may cause disengagement from the drive shafts. Specifically, the flexible shafts, which are typically made of pluralities of helically twisted wires, may lose or increase in length if a torque that is greater than a predetermined threshold amount is supplied thereto. The decreased length may create reduced engagement between the flexible shafts and drive shaft. Consequently, the shafts may disengage from one another and damage to the moveable thrust reverser components or other components may result. Thermal affects further aggravate this because the flexible shafts expand at different rates than the housing.

Accordingly, there is a need for a thrust reverser system that improves upon one or more of the drawbacks identified above. Namely, a system is desired that provides synchronized deployment of the transcowls without inadvertent disengagement of the flexible shaft and the drive shafts. The present invention addresses one or more of these needs.

### BRIEF SUMMARY

The present invention provides a coupler for coupling a first cable to a second cable, where the first cable includes a male adapter having a male drive feature extending therefrom, and the second cable includes a female adapter having a female drive feature extending therefrom, each adapter including a radial flange. In one embodiment, and by way of example only, the coupler includes a cylinder, a female drive receiving end, and a male drive receiving end. The cylinder includes a first end, a second end, and a channel extending therebetween. The female drive receiving end is formed on the cylinder first end and includes an inlet in communication with the channel. The inlet has a diameter that is greater than a diameter of the female drive feature and less than a diameter of the female adapter radial flange. The male drive receiving end is formed on the cylinder second end and includes an inlet in communication with the channel. The inlet has a diameter that is greater than a diameter of the male drive feature and less than a diameter of the male adapter radial flange. The male drive receiving end is spaced a predetermined distance apart from the female drive receiving end such that when the female and male drive features are disposed in the cylinder channel, a portion of the male drive feature is disposed in the female drive feature and is capable of moving axially therethrough in response to a predetermined torque applied to the first cable.

In another embodiment, a coupling system is provided. By way of example only, the coupling system includes a first cable, a male adapter, a second cable, a female adapter, and a coupler. The male adapter is coupled to the first cable and includes a male drive feature extending therefrom and a radial flange formed thereon. The female adapter is coupled to the second cable and has a female drive feature extending therefrom and a radial flange formed thereon. The coupler is disposed between the first and the second cables and includes a female drive receiving end, a male drive receiving end, and a channel extending therebetween. The female drive receiving end includes an inlet in communication with the channel through which the female drive feature extends, and the inlet has a diameter that is less than a diameter of the female adapter radial flange. The male drive receiving end includes an inlet in communication with the channel through which the male drive feature extends, and the inlet has a diameter that is less than a diameter of the male adapter radial flange. The male drive receiving end is spaced a predetermined distance apart from the female drive receiving end such that a portion of the male drive feature is disposed in the female drive feature and is capable of moving axially therethrough in response to a predetermined torque applied to the first cable.

In another embodiment, a thrust reverser actuation system is provided. The system includes at least two power drive units, at least two drive mechanisms, at least two actuators and a coupling system. The at least two power drive units are each independently operable to supply a drive force. The at least two drive mechanisms are each coupled to receive the drive force from one of the at least two power drive units. Each actuator is coupled to one of the at least two drive mechanisms to receive the drive force from one of the at least two drive mechanisms, and each of the at least two actuators has at least one end that rotates in response to the drive force and configured to move, upon receipt of the drive force, between a stowed position and a deployed position. The coupling system couples together the at least two power drive units and is configured to transfer power between the at least two drive units to synchronize movement of the at least two actuators. The coupling system includes a first cable, a male adapter, a second cable, a female adapter, and a coupler. The male adapter is coupled to the first cable and includes a male drive feature extending therefrom and a radial flange formed thereon. The female adapter is coupled to the second cable and has a female drive feature extending therefrom and a radial flange formed thereon. The coupler is disposed between the first and the second cables and includes a female drive receiving end, a male drive receiving end, and a channel extending therebetween. The female drive receiving end includes an inlet in communication with the channel through which the female drive feature extends, and the inlet has a diameter that is less than a diameter of the female adapter radial flange. The male drive receiving end includes an inlet in communication with the channel through which the male drive feature extends, and the inlet has a diameter that is less than a diameter of the male adapter radial flange. The male drive receiving end is spaced a predetermined distance apart from the female drive receiving end such that a portion of the male drive feature is disposed in the female drive feature and is capable of moving axially therethrough in response to a predetermined torque applied to the first cable

Other independent features and advantages of the preferred system will become apparent from the following detailed description, taken in conjunction with the accompanying drawings which illustrate, by way of example, the principles of the invention.

### BRIEF DESCRIPTION OF THE DRAWINGS

FIG. 1 is a perspective view of portions of an aircraft jet engine fan case;

FIG. 2 is a simplified end view of a thrust reverser actuation system according to an exemplary embodiment of the present invention;

FIG. 3 is a cross section view of an exemplary coupling system that may be implemented into the thrust reverser actuation system depicted in FIG. 2; and

FIG. 4 is an exemplary coupler shown in the coupling system depicted in FIG. 3.

### DETAILED DESCRIPTION OF A PREFERRED EMBODIMENT

Before proceeding with the detailed description, it is to be appreciated that the described embodiment is not limited to use in conjunction with a specific thrust reverser system design. Thus, although the description is explicitly directed toward an embodiment that is implemented in a cascade-type thrust reverser system, in which transcowls are used as the moveable thrust reverser component, it should be appreciated that it can be implemented in other thrust reverser actuation system designs, including those described above and those known now or hereafter in the art.

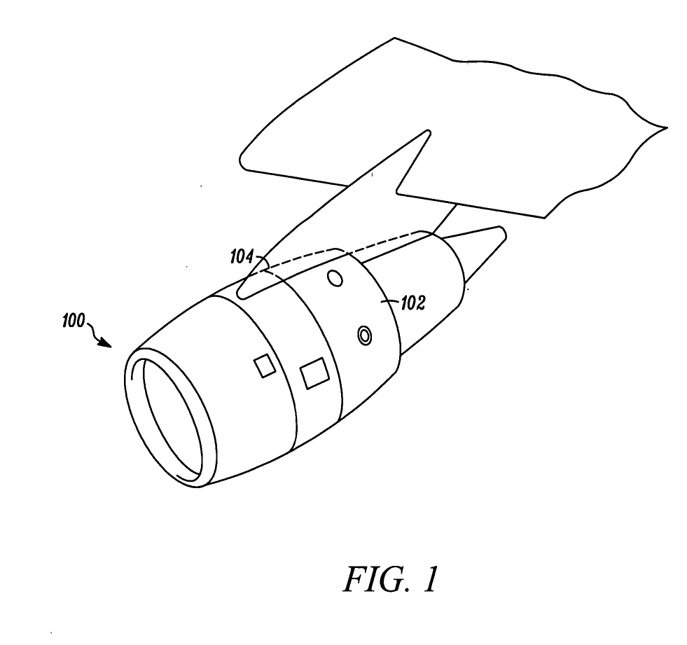

Turning now to the description, and with reference first to FIG. 1, a perspective view of portions of an aircraft jet engine fan case 100 that incorporates a cascade-type thrust reverser is depicted. The engine fan case 100 includes a pair of semi-circular transcowls 102, 104 that are positioned circumferentially on the outside of the fan case 100. The transcowls 102 and 104 cover a plurality of non-illustrated cascade vanes, and may be maintained and aligned on non-illustrated translation guides via a mechanical link 106. It will be appreciated that any one of numerous suitable linking devices may be employed, such as, for example, a pin or a latch. When the thrust reversers are commanded to deploy, the transcowls 102, 104 translate aft. This, among other things, exposes the cascade vanes, and causes at least a portion of the air flowing through the engine fan case 100 to be redirected, at least partially, in a forward direction. The re-directed forward air flow creates a reverse thrust to slow the aircraft.

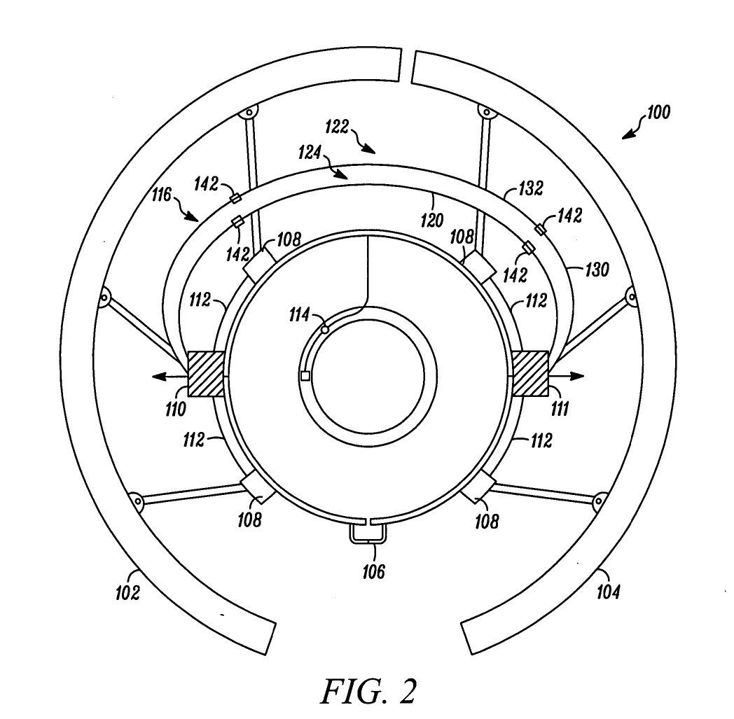

As shown more clearly in FIG. 2, a plurality of actuator assemblies 108 are individually coupled to the transcowls 102, 104. In the depicted embodiment, half of the actuator assemblies 108 are coupled to one of the transcowls 102, and the other half are coupled to another transcowl 104. While not critical to understand or enable the present invention, it is noted that some or all of the actuator assemblies 108 may include locks, some or all of which may include position sensors. The actuator assemblies 108 used in the thrust reverser system 100 may be any one of numerous actuator designs presently known in the art or hereafter designed. However, in the depicted embodiment the actuator assemblies 108 are ballscrew type end actuators. It is additionally noted that the number and arrangement of the actuator assemblies 108 is not limited to what is depicted in FIG. 2, but could include other numbers of actuator assemblies 108 as well. The number and arrangement of actuators is selected to meet the specific design requirements of the system.

The actuator assemblies 108 are interconnected via a plurality of drive mechanisms 112, each of which, in the particular depicted embodiment, is a flexible shaft. Using flexible shafts in this configuration preferably ensures that the actuator assemblies 108 and the transcowls 102, 104 move in a substantially synchronized manner. For example, when one transcowl 102 is moved, the other transcowl 104 is moved a like distance at substantially the same time.

At least two power drive unit (PDU) assemblies 110, 111 are coupled to the actuator assemblies 108 on each transcowl 102, 104 via one or more flexible shafts 112. The PDU assemblies 110, 111 are controlled by a control valve 114 and share a common pneumatic supply (not shown). The control valve 114 receives commands from a non-illustrated controller that provides appropriate activation and deactivation signals to the PDU assemblies 110, 111 in response to the received commands. In turn, the PDU assemblies 110, 111 each supply a drive force to their respective actuator assemblies 108 via the flexible shafts 112. In the illustrated embodiment, the PDU assemblies 110, 111 each supply a drive force to a first and second actuator assembly. As a result, the actuator assemblies 108 cause the transcowls 102, 104 to translate between the stowed and deployed positions.

The thrust reverser system 100 further includes a synchronization assembly 116 that redundantly couples the PDU assemblies 110, 111 and provides synchronization of the actuator assemblies 108, and thus the transcowls 102, 104. More specifically, the synchronization assembly 116 includes at least two flexible synchronizing shafts 118, 120 that couple the PDU assemblies 110, 111 to one another. The synchronizing shafts 118, 120 are configured to transfer power between the PDU assemblies 110, 111 for synchronizing movement of the actuators 108 associated with transcowl 102 with movement of the actuators 108 associated with transcowls 104. Although dual synchronizing shafts 118, 120 have been utilized in this embodiment to provide a fault tolerant actuation system, it will be appreciated that a single synchronization shaft could alternatively be employed in synchronization assembly 116 when so needed or desired.

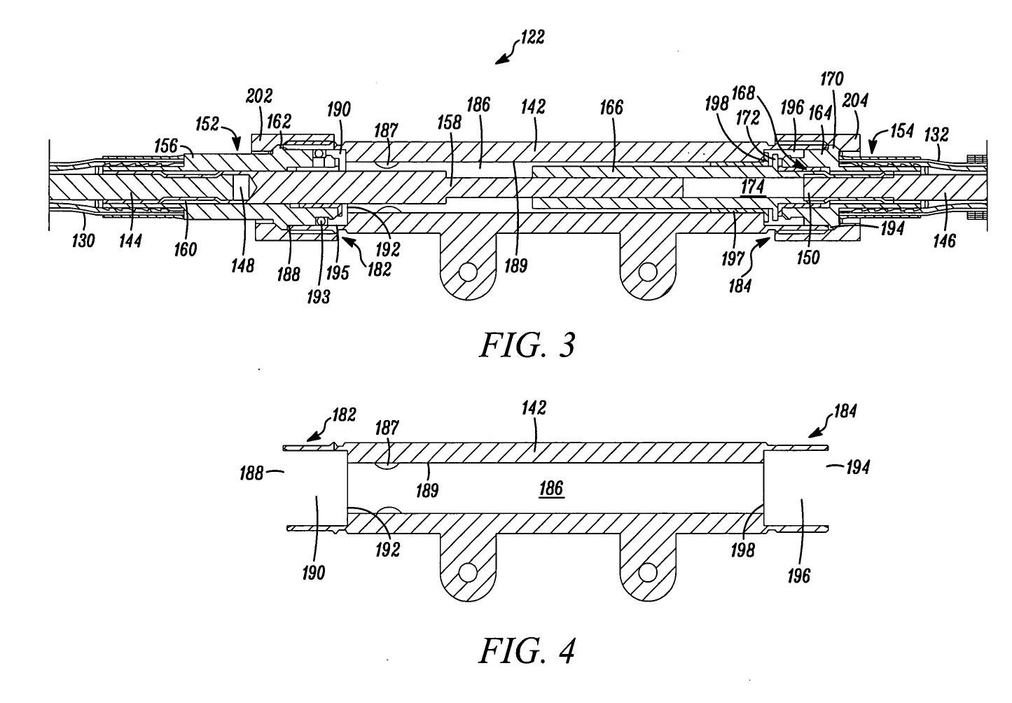

At times, the synchronization shafts 118, 120 may be subjected to relatively large magnitudes of torque or high temperatures, which may cause the shafts 118, 120 to decrease or increase in length. To compensate for the change in length, each shaft 118, 120 includes a coupling system 122, 124. FIG. 3 illustrates one section of an exemplary coupling system 122 which includes two short cable sections, 130, 132 coupled together by a coupler 142. The cables 130, 132 each include a core 144, 146 that, in some embodiments, may be a plurality of helically twisted coaxial wires. Alternatively, in other embodiments, it will be appreciated that the cores 144, 146 may be a single, relatively thick wire, or a plurality of straight coaxial wires. Each core 144, 146 includes an end 148, 150 that is coupled to a male and a female adapter 152, 154, respectively. Although the first cable 130 is shown herein as being coupled to the male adapter 152 and the second cable 132 is shown as being coupled to the female adapter 154, it will be appreciated that the first and second cables 130, 132 may alternatively be coupled to the female and male adapters 154, 152, respectively.

Each of the male and female adapters 152, 154 has a conventional configuration. For example, the male adapter 152 includes a sleeve 156 and a male drive feature 158 extending therefrom. The sleeve 156 has an axial channel 160 within which the first cable core end 148 is disposed and contacts the male drive feature 158. Additionally, the sleeve 156 has a radial flange 162 extending therefrom. Although the radial flange 162 is shown in FIG. 3 as being formed substantially in the middle of the sleeve 156, it will be appreciated that the radial flange 162 may alternatively be formed in any other suitable portion thereof.

Similar to the male adapter 152, the female adapter 154 includes a sleeve 164 and a female drive feature 166 extending therefrom. The sleeve 164 has an axial channel 168 within which the second cable core end 150 is disposed and contacts the female drive feature 166. A radial flange 170 is formed proximate a mid-section of the sleeve 164; however, it will be appreciated that the radial flange 170 may alternatively be formed in any other suitable section of the sleeve 164. The female drive feature 166 also includes a radially extending flange 172 formed thereon that abuts the female adapter sleeve 164. It will be appreciated that the female drive feature 166 includes an axial channel 174 formed therethrough that is configured to engage with the male drive feature 158 when the coupling system 122 is assembled. In some embodiments, the female drive feature axial channel 174 may have a cross sectional shape (e.g. hexagonal, circular, square, etc.) that corresponds with the shape of the cross section of the male drive feature 158.

Referring now to FIGS. 3 and 4, the coupler 142 is configured to maintain the first cable 130 in place relative thereto and to allow the second cable 132 to free float relative thereto. In this regard, the coupler 142 is generally cylindrical and includes a male drive receiving end 182, a female drive receiving end 184, and a channel 186. The male drive receiving end 182 includes an inlet 188, an outlet 192, and a cavity 190 formed therebetween that communicates with the channel 186. Preferably, the inlet 188 is configured to allow entry of the male drive feature 158 and a section of the male adapter sleeve 156 up to the male adapter sleeve radial flange 162. Thus, the inlet 188 has a diameter that is greater than the outer diameter of the male adapter sleeve 164 and less than the diameter of the male adapter sleeve radial flange 162.

The cavity 190 accommodates the section of the male adapter 152 up to the sleeve radial flange 162 and includes a suitable axial length. In some embodiments, an o-ring 193 may be coupled to an inner surface 195 of the cavity 190 to thereby secure the male adapter 152 therein. The outlet 192 is configured to allow entry of the male drive feature 158 and has a suitable diameter to do so. In another exemplary embodiment, the outlet 192 also prevents entry of the male adapter 152 and thus the diameter thereof is less than the male adapter 152 diameter and greater than the diameter of the male drive feature 158.

With continued reference to FIGS. 3 and 4, the female drive receiving end 184 also includes an inlet 194, an outlet 198, and a cavity 196 that communicates with the channel 186. Preferably, the inlet 194 is configured to allow entry of the female drive feature 166 and a section of the female adapter sleeve 164 up to its sleeve radial flange 170. In this regard, the inlet 194 has a diameter that is greater than the outer diameter of the female adapter sleeve 164 and less than the diameter of the female adapter sleeve radial flange 170. The cavity 196 has an axial length that accommodates at least the section of the female adapter 154 up to the sleeve radial flange 170 and a portion of the female drive feature 166. The cavity 196 axial length is also preferably suitably sized to compensate for a change in length of the female drive feature 166 that may result from thermal expansion of the second cable core 146.

To maintain the female adapter 154 substantially positioned relative to the coupler 142, the outlet 198 has a diameter that is less than the diameter of the female drive feature radially extending flange 172 and greater than a diameter of the female drive feature 166. To further substantially secure the female drive feature 166 in place, a bushing 197 having a diameter that is substantially equal to the female drive feature 166 outer diameter may be placed in the channel 186 proximate the outlet 198. Each adapter 152, 154 is secured to the coupler 142 using any one of numerous conventional fasteners, such as, for example, a nut 202, 204, as shown in FIG. 3.

The male and female drive receiving ends 182, 184 are configured to be spaced apart a predetermined distance such that when the coupling system 122 is assembled and the male and female drive features 158, 166 are disposed in the coupler channel 186, a predetermined length of the male drive feature 158 is disposed in and extends into the female drive feature axial channel 180. The particular predetermined length may depend on an anticipated amount of torque that may be applied to the first cable 130 in addition to a change in length of the first cable core 144 due to thermal expansion thereof.

To ensure that the correct drive feature 158, 166 is disposed in the coupler channel 186, projections 187 may be included thereon. The projections 187 may be any one of numerous suitable mechanisms that may be used to discern the male drive feature 158 from the female drive feature 166. For example, the projections 187 may be formed on an inner wall 189 of the coupler 142 and protrude into the coupler channel 186, or alternatively, the projections 187 may be drive features that extend at least partially into the coupler channel 186.

During operation when a torque is applied to the first cable 130, the first cable core 144 applies a pressure against the male drive feature 158 causing it to move axially with respect to the female drive feature axial channel 158. When the second cable 132 experiences thermal expansion such that the second cable core 146 lengthens, the female drive feature 166 is pushed further into the coupler channel 186 until the female drive feature radially extending flange 172 contacts the coupler 142.

A system has now been provided that synchronizes deployment of the transcowls without inadvertent disengagement of the flexible shaft and the drive shafts. Specifically, a plurality of cables make up the flexible shaft and are provided with couplers disposed therebetween that allow the cables to lengthen and shorten relative to one another due to the application of a torque and/or exposure to heat. Thus, because the cables have slack therebetween, the likelihood of the flexible shaft becoming disengaged from the drive shaft is minimized. The system is relatively simple and inexpensive to incorporate. Moreover, the system may be retrofitted into existing thrust reverser actuation systems.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A coupler for coupling a first cable to a second cable, the first cable including a male adapter having a male drive feature extending therefrom, and the second cable including a female adapter having a female drive feature extending therefrom, each adapter including a radial flange, the coupler comprising:
a cylinder including a first end, a second end, and a channel extending therebetween;
a female drive receiving end formed on the cylinder first end including an inlet in communication with the channel, the inlet having a diameter that is greater than a diameter of the female drive feature and less than a diameter of the female adapter radial flange; and
a male drive receiving end formed on the cylinder second end including an inlet in communication with the channel, the inlet having a diameter that is greater than a diameter of the male drive feature and less than a diameter of the male adapter radial flange, the male drive receiving end spaced a predetermined distance apart from the female drive receiving end such that when the female and male drive features are disposed in the cylinder channel, a portion of the male drive feature is disposed in the female drive feature and is capable of moving axially therethrough in response to a predetermined torque applied to the first cable.

2. The coupler of claim 1, wherein
the female drive feature includes a radially extending flange formed thereon, the female drive feature radially extending flange having a diameter; and
the female drive receiving end includes a cavity formed between the female drive feature inlet and the cylinder channel, the cavity including an outlet in communication with the cylinder channel having a diameter that is less than the female drive feature radially extending flange diameter.

3. The coupler of claim 2, wherein:
a distance between the female adapter radial flange and the female drive feature radially extending flange increases in response to thermal expansion of the second cable to a predetermined length; and
the female drive receiving end cavity includes a predetermined axial length that is substantially equal to the predetermined length.

4. The coupler of claim 1, wherein:
the male drive receiving end includes a cavity formed between the male drive feature inlet and the cylinder channel, the cavity including an outlet in communication with the cylinder channel having a diameter that is less than the male adapter radial flange diameter.

5. The coupler of claim 1, further comprising a projection extending radially into the cylinder channel.

6. The coupler of claim 1, further comprising an interior sleeve disposed at least partially in the cylinder channel, the interior sleeve having an inner diameter that is substantially equal to the diameter of the female drive feature.

7. The coupler of claim 1, further comprising:
a first nut fastened to the male drive receiving end.

8. The coupler of claim 7, further comprising:
a second nut fastened to the female drive receiving end.

9. A coupling system comprising:
a first cable;
a male adapter coupled to the first cable, the male adapter including a male drive feature extending therefrom and a radial flange formed thereon;
a second cable;
a female adapter coupled to the second cable having a female drive feature extending therefrom and a radial flange formed thereon; and
a coupler disposed between the first and the second cables including a female drive receiving end, a male drive receiving end, and a channel extending therebetween, the female drive receiving end including an inlet in communication with the channel through which the female drive feature extends, the inlet having a diameter that is less than a diameter of the female adapter radial flange, and the male drive receiving end including an inlet in communication with the channel through which the male drive feature extends, the inlet having a diameter that is less than a diameter of the male adapter radial flange,
wherein the male drive receiving end is spaced a predetermined distance apart from the female drive receiving end such that a portion of the male drive feature is disposed in the female drive feature and is capable of moving axially therethrough in response to a predetermined torque applied to the first cable.

10. The coupling system of claim 9, wherein
the female drive feature includes a radially extending flange formed thereon, the female drive feature radially extending flange having a diameter; and
the female drive receiving end includes a cavity formed between the female drive feature inlet and the cylinder channel, the cavity including an outlet in communication with the cylinder channel having a diameter that is less than the female drive feature radial flange diameter.

11. The coupling system of claim 10, wherein:
a distance between the female adapter radial flange and the female drive feature radially extending flange increases in response to thermal expansion of the second cable to a predetermined length; and
the female drive receiving end cavity includes a predetermined axial length that is substantially equal to the predetermined length.

12. The coupling system of claim 9, wherein:
the male drive receiving end includes a cavity formed between the male drive feature inlet and the cylinder channel, the cavity including an outlet in communication with the cylinder channel having a diameter that is less than the male adapter radial flange diameter.

13. The coupling system of claim 9, further comprising a projection extending radially into the cylinder channel.

14. The coupler of claim 9, further comprising an interior sleeve disposed at least partially in the cylinder channel, the interior sleeve having an inner diameter that is substantially equal to the diameter of the female drive feature.

15. The coupling system of claim 9, further comprising:
a first nut fastened to the male drive receiving end.

16. The coupling system of claim 15, further comprising:
a second nut fastened to the female drive receiving end.

17. The coupling system of claim 9, wherein:
the first cable comprises a core;
the male adapter comprises a sleeve; and
a portion of the core and a portion of the male drive feature are disposed in the male adapter sleeve and in contact with each other.

18. The coupling system of claim 17, wherein:
the second cable comprises a core;
the female adapter comprises a sleeve; and
a portion of the core and a portion of the female drive feature are disposed in the female adapter sleeve and in contact with each other.

19. A thrust reverser actuation system, comprising:
at least two power drive units each independently operable to supply a drive force;
at least two drive mechanisms each coupled to receive the drive force from one of the at least two power drive units;
at least two actuators, each actuator coupled to one of the at least two drive mechanisms to receive the drive force from one of the at least two drive mechanisms, each of the at least two actuators having at least one end that rotates in response to the drive force and configured to move, upon receipt of the drive force, between a stowed position and a deployed position; and
a coupling system coupling together the at least two power drive units and configured to transfer power between the at least two drive units to synchronize movement of the at least two actuators, the coupling system comprising:
a first cable;
a male adapter coupled to the first cable, the male adapter including a male drive feature extending therefrom and a radial flange formed thereon;
a second cable;
a female adapter coupled to the second cable having a female drive feature extending therefrom and a radial flange formed thereon;
a coupler disposed between the first and the second cables including a female drive receiving end, a male drive receiving end, and a channel extending therebetween, the female drive receiving end including an inlet in communication with the channel through which the female drive feature extends, the inlet having a diameter that is less than a diameter of the female adapter radial flange, and the male drive receiving end including an inlet in communication with the channel through which the male drive feature extends, the inlet having a diameter that is less than a diameter of the male adapter radial flange,
wherein the male drive receiving end is spaced a predetermined distance apart from the female drive receiving end such that a portion of the male drive feature is disposed in the female drive feature and is capable of moving axially therethrough in response to a predetermined torque applied to the first cable.

20. The thrust reverser actuation system of claim 19 wherein:
the female drive feature includes a radially extending flange formed thereon, the female drive feature radially extending flange having a diameter; and
the female drive receiving end includes a cavity formed between the female drive feature inlet and the cylinder channel, the cavity including an outlet in communication with the cylinder channel having a diameter that is less than the female drive feature radial flange diameter
